(19) United States
(12) Patent Application Publication
(10) Pub. No.: US 2011/0215731 A1
(43) Pub. Date: Sep. 8, 2011

(54) LED ILLUMINATION DRIVING APPARATUS

(75) Inventors: Yeon Moon JEONG, Yongin-si (KR); Kang Wha Chung, Seoul (KR)

(73) Assignee: LIGHTGREEN CONCEPT CO., LTD., Seoul (KR)

(21) Appl. No.: 13/036,338

(22) Filed: Feb. 28, 2011

(30) Foreign Application Priority Data
Mar. 3, 2010 (KR) 10-2010-0018941

(51) Int. Cl. H05B 41/282

(52) U.S. Cl. 315/254

(57) ABSTRACT

Provided is an LED illumination driving apparatus. When dimming is performed in the LED illumination apparatus, the power voltage level supplied to an LED module is selectively adjusted according to illuminance to prevent the flicker phenomenon occurring due to an excessive decrease in a duty ratio of a PWM control signal at a dimming time in the related art. More specifically, if the set illuminance is decreased by a user, the duty ratio of the PWM control signal is decreased, so that the illuminance of the LED illumination is decreased. When the duty ratio of the PWM control signal is decreased, if the user decreases the illuminance below a predetermined level corresponding to a threshold duty ratio where the flicker phenomenon occurs, the power voltage level transmitted to the LED module is decreased. The duty ratio is allowed to be increased again by the duty ratio corresponding to the decrease in the power voltage level, and after that, the duty ratio is allowed to be decreased again. Accordingly, it is possible to freely adjust the illuminance of the LED illumination apparatus while preventing the occurrence of the flicker phenomenon.

### TECHNICAL FIELD

The present invention relates to an LED illumination driving apparatus, and more particularly, to an LED illumination driving apparatus capable of preventing a flicker phenomenon at the dimming time.

### BACKGROUND ART

Recently, much attention has been paid to LED illumination having low power consumption as well as a degree of the illuminance of the illumination apparatus such as an incandescent lamp. LED illumination driving apparatuses for driving the LED illumination apparatus by controlling the current so that constant current is flowed in the LED illumination apparatus have been actively researched and developed. Such an LED illumination driving apparatus has various illumination exhibition functions. In particular, various illumination exhibitions can be performed by changing dimming of the LED devices which are arrayed in serial and parallel connection.

In the method of driving the LED devices used for the conventional LED illumination apparatuses, the current applied to the LED device is controlled in a PWM control manner where the LED device is intermittently lit up and out at a high speed so that the lighting-up and the lighting-out are not perceived by human eyes. Therefore, it is possible to prevent the deterioration in performance and the shortening of the lifetime caused by the continuous lighting-up of the LED device.

In particular, if needed, in the case where the dimming is performed to adjust the illuminance, in the conventional method, the dimming is performed by adjusting a current amount applied to the LED device by changing a duty ratio of a PWM control signal.

In addition, as illustrated in FIG. 1, in most conventional LED dimming lamp mechanisms, an angle of flow of an external AC power is adjusted by using a triac, or the like. Therefore, according to the adjustment of the output of the triac, a non-power period is overlapped with the duty of the PWM signal, so that the more serious flicker phenomenon occurs. In order to prevent this problem, an electrolytic condenser is disposed at the rear stage of AC rectification to output a DC power. The power is smoothed by smoothing the non-power portion generated in the power control using the triac and the zero-crossing portion of 120 Hz generated at the full wave rectification of a diode are smoothed so that the flicker phenomenon does not occur. Therefore, it is possible to prevent the flicker phenomenon from occurring when the power is supplied to the LED device in the PWM manner.

FIG. 2 is a diagram illustrating a waveform of a PWM control signal used to control a conventional LED illumination apparatus at the dimming operation time.

Referring to FIG. 2, a PWM control signal used for a general illumination situation is illustrated in (a) of FIG. 2. In the example illustrated in FIG. 2, a duty ratio of the PWM control signal is exemplified to be 60%.

After that, in order to increase the illuminance of the LED illumination, as illustrated in (b) of FIG. 2, the more current is allowed to be supplied to the LED device by increasing the duty ratio (in the case (b) of FIG. 2, the duty ratio is 80%). On the contrary, in order to decrease the illuminance like the dimming, as illustrated in (c) of FIG. 2, the less current is allowed to be supplied to the LED device by decreasing the duty ratio.

However, if the duty ratio is decreased in the dimming time, the interval between the pulses is increased, so that the time taken from the lighting-out to the lighting-up of the LED device is increased. Therefore, the repetition of the lighting-up and the lighting-out of the LED device in the interval between the pulses can be perceived by human eyes. In the other words, a flicker phenomenon occurs. Therefore, there is a limitation in decreasing the illuminance of the LED illumination in the dimming mode.

### DISCLOSURE

### Technical Problem

The present invention provides an LED illumination driving apparatus capable of performing dimming without occurrence of the flicker phenomenon when LED illumination is operated in a dimming mode.

### Technical Solution

According to an aspect of the present invention, there is provided an LED illumination driving apparatus including: a rectifier which rectifies an input AC power; a transformation circuit which transforms a magnitude of a DC power input from the rectifier according to a first control signal and outputs the transformed DC power to an LED module; an illuminance setting unit which receives a set illuminance value as an input; a constant current sustaining unit which generates a second control signal so that a constant current is flowed in the LED module; and a driving controller which receives the set illuminance value and the second control signal as input and outputs the first control signal determining an operation period of the transformation circuit and a magnitude of the transformed power which is to be output from the transformation circuit.

In addition, the transformation circuit may include: a transformer including a primary winding connected to the rectifier and a secondary winding connected to the LED module; and a plurality of switches which turn on according to the first control signal to change the number of turns of the primary winding and adjust an operation time of the transformer.

In addition, the driving controller may output the first control signal to any one of the switches according to the set illuminance value.

In addition, the plurality of switches may be constructed with MOSFETs, wherein the first control signal may be applied to the gates of the MOSFETs, and wherein the drain of one of the MOSFETs may be connected to an end portion of the primary winding and the drain of another MOSEFT may be connected to a central portion of the primary winding, so that the magnitude of the power transmitted to the LED module can be changed by changing the turns ratio of the transformer.

In addition, the driving controller may generate a PWM control signal as the first control signal and control the operation time of the transformer by changing a duty ratio of the PWM control signal.

In addition, the constant current sustaining unit may include: a current measurement module which measures a magnitude of the current flowing in the LED module, comparing the magnitude of the current with a reference current value, and outputting the second control signal; and a reference current value setting unit which adjusts a magnitude of the reference current value.

In addition, the reference current value setting unit may change the magnitude of the reference current value corresponding to the switch, which receives the first control signal as input, among the plurality of switches.

### ADVANTAGEOUS EFFECTS

As described above, according to the present invention, when dimming is performed in the LED illumination apparatus, the power voltage level supplied to an LED module is selectively adjusted according to illuminance to prevent the flicker phenomenon occurring due to an excessive decrease in a duty ratio of a PWM control signal at a dimming time in the related art. More specifically, if the set illuminance is decreased by a user, the duty ratio of the PWM control signal is decreased, so that the illuminance of the LED illumination is decreased. When the duty ratio of the PWM control signal is decreased, if the user decreases the illuminance below a predetermined level corresponding to a threshold duty ratio where the flicker phenomenon occurs, the power voltage level transmitted to the LED module is decreased. The duty ratio is allowed to be increased by the duty ratio corresponding to the decrease in the power voltage level, and after that, the duty ratio is allowed to be decreased again. Accordingly, it is possible to freely adjust the illuminance of the LED illumination apparatus while preventing the occurrence of the flicker phenomenon.

Therefore, it is also possible to decrease a value of Vf of the LED device, so that the lifetime of the LED can be increased.

### DESCRIPTION OF DRAWINGS

FIG. 1 is a diagram illustrating a triac power dimming circuit of a conventional lamp mechanism.

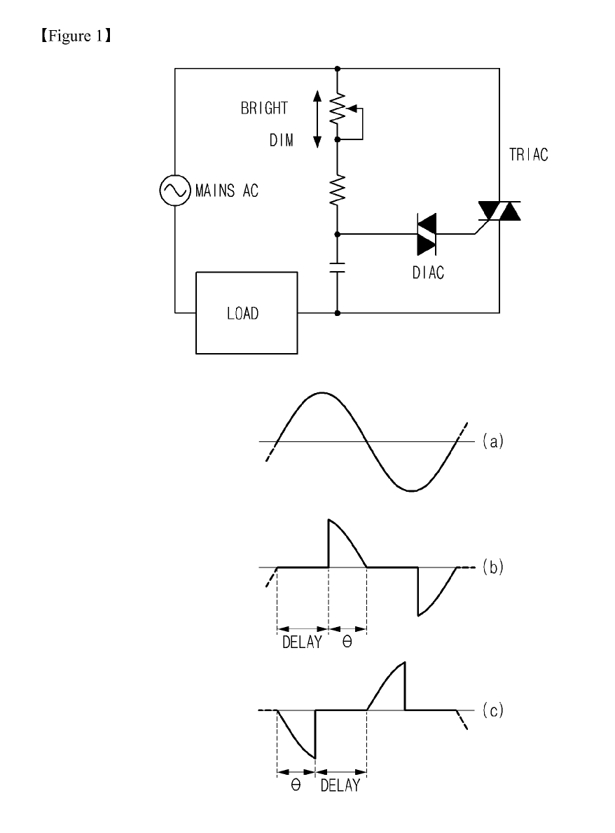

FIG. 2 is a diagram illustrating a waveform of a PWM control signal used to control a conventional LED illumination apparatus at the dimming operation time.

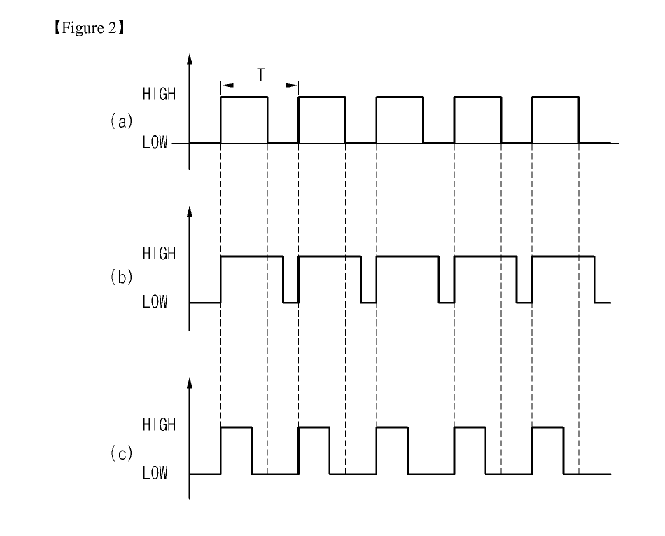

FIG. 3 is a diagram illustrating an example of a PWM control pulse and a power pulse applied to an LED module at the PWM control pulse according to a preferred embodiment of the present invention.

FIG. 4 is a conceptual block diagram illustrating an overall configuration of the LED illumination driving apparatus according to the preferred embodiment of the present invention.

FIG. 5 is a circuit diagram illustrating a circuit configuration of the LED illumination driving apparatus according to the preferred embodiment of the present invention.

FIG. 6 is a diagram illustrating an example of a circuit of a current sensing module of a constant current sustaining unit according to the preferred embodiment of the present invention.

FIG. 7 is a circuit diagram illustrating a detailed configuration of a driving controller 340 according to the preferred embodiment of the present invention.

### BEST MODE

Hereinafter, preferred embodiments of the present invention will be described with reference to the accompanying drawings.

First, a concept of a driving method performed in an LED illumination driving apparatus according to a preferred embodiment of the present invention is described in brief. As described above, in a dimming method performed in the related art, when a power applied to an LED is controlled in a PWM control method, if a duty ratio of the PWM signal is decreased so as to decrease illuminance of the LED module, an interval between pulses is increased, so that the flicker phenomenon occurs.

In the present invention, control is performed so that the duty ratio is not equal to or lower than a threshold value, where the flicker phenomenon occurs, in order to prevent occurrence of the flicker phenomenon, and the magnitude of the power applied to the LED module is allowed to be decreased in order to reduce the illuminance of the LED while maintaining the duty ratio to be equal to or larger than the threshold value. Therefore, in the present invention, the magnitude of an external input power is transformed by two steps and, after that, applied to the LED module. In each level of the magnitude of the power, a pulse width of the PWM control signal is controlled, so that the illuminance can be adjusted.

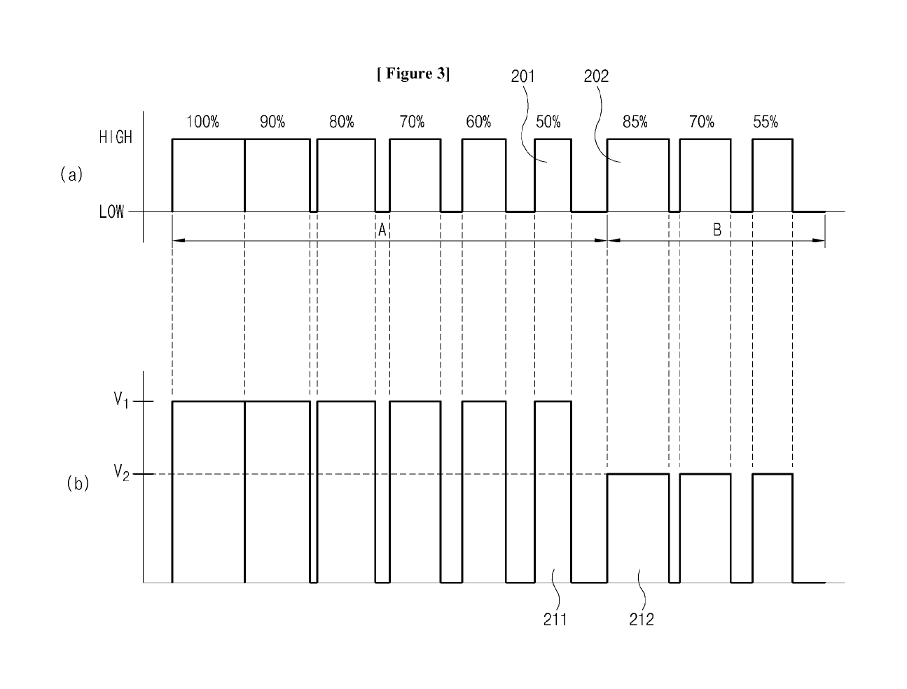

FIG. 3 is a diagram illustrating an example of a PWM control pulse and a power pulse applied to an LED module at the PWM control pulse according to a preferred embodiment of the present invention.

(a) of FIG. 3 illustrates the PWM control pulse generated in a process of gradually decreasing the illuminance from the maximum value to the minimum value according to the preferred embodiment of the present invention, and (b) of FIG. 3 illustrates a magnitude of the power pulse applied to an LED module corresponding to each pulse of (a) of FIG. 3.

In (b) of FIG. 3, V1 is assumed to be the maximum voltage which can be applied without destruction of the LED device when the duty ratio is 100%, and V2 is assumed to be the voltage which is set so that the LED is driven by a suitable duty ratio without the lighting-out. The lowest threshold duty ratio where the flicker phenomenon does not occur in the LED module is assumed to be 50%. When the maximum voltage of the power is V1, it is assumed that the illuminance is decreased by 5 every time when the duty ratio is decreased by 10%.

First, in the case where the illuminance of the LED module illustrated in (a) of FIG. 3 is in maximum (the maximum value of the power pulse is set to V1, the duty ratio is set to 100%, and the illuminance is set to 100), the PWM control pulse is generated so that the illuminance is gradually decreased by 5. Accordingly, in the state where the maximum voltage value of the power pulse applied to the LED module is V1, the duty ratio is gradually decreased by 10%, and thus, the energy supplied to the LED module is decreased, so that the illuminance is gradually decreased. In this manner, if the duty ratios of the control signal and the power are allowed to be decreased, the duty ratios reach the threshold duty ratio (50%) where the LED can be lit up without occurrence of the flicker phenomenon (Area A).

Next, in order to further decrease the illuminance, the energy supplied to the LED module needs to be decreased while the duty ratio is maintained to be equal to or larger than 50%. Therefore, as illustrated in (b) of FIG. 3, the maximum voltage value of the power pulse is set to V2 which is lower than V1, and a pulse 212 of which pulse width is larger than that of a previous pulse 211 is applied as a power pulse to an LED module 400. Accordingly, it can be understood that, in the PWM control pulse, a pulse 202 having an increased duty ratio of 85% is generated after a pulse 201 having a duty ratio of 50%. Next, similarly to the area A, the duty ratio is decreased in the state where the maximum voltage value is maintained to be V2, so that the illuminance can be gradually decreased (Area B).

In the example illustrated in FIG. 3, the magnitude of the power is classified into two steps V1 and V2. However, the magnitude of the power may be classified into the more number of steps in the magnitude of the power.

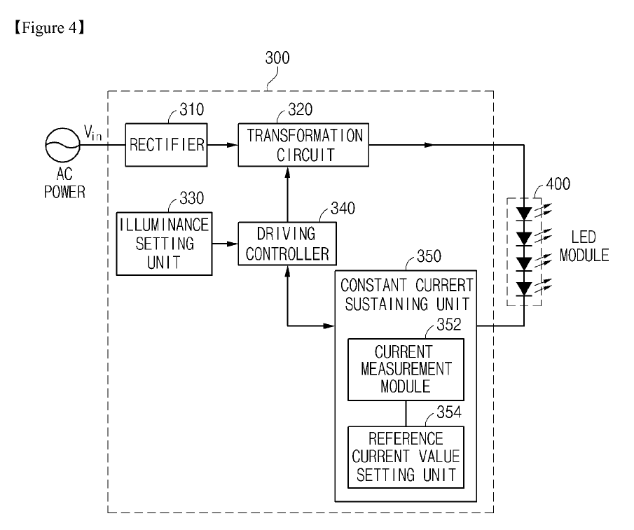

FIG. 4 is a conceptual block diagram illustrating an overall configuration of the LED illumination driving apparatus according to the preferred embodiment of the present invention. Referring to FIG. 4, the LED illumination driving apparatus according to the preferred embodiment of the present invention is configured to include a rectifier 310, a transformation circuit 320, an illuminance setting unit 330, a driving controller 340, and a constant current sustaining unit 350. First, the rectifier 310 rectifies an external input AC power in a full wave manner to convert the AC power to a DC power and outputs the converted DC power which is not smoothed to the transformation circuit 320.

The transformation circuit 320 transforms the magnitude of the DC power input from the rectifier 310 according to the first control signal input from the driving controller 340 and supplies the transformed DC power to the LED module 400. As described above with reference to FIG. 3, the transformation circuit 320 transforms the maximum voltage of the input power to V1 or V2 and outputs V1 or V2. In addition, the transformation circuit 320 intermittently transforms the input signal according to the first control signal to convert the input power having an analog form into a power having a pulse form and supplies the pulse to the LED module 400. The transformation circuit 320 may be configured to include a transformer including a primary winding connected to the rectifier 310 and a secondary winding connected to the LED module 400 and a plurality of switches which turn on according to the first control signal input from the driving controller 340 to change the number of turns of the primary winding and adjust an operation time of the transformer.

The plurality of switches may be constructed with MOSFETs. In this case, the first control signal is applied to the gate of the MOSFET. The drain of one of the MOSFETs is connected to an end portion of the primary winding, and the drain of another MOSFET is connected to a middle portion of the primary winding, so that the turns ratio of the transformer can be changed. Accordingly, the magnitude of the power voltage supplied to the LED module 400 can be changed.

The illuminance setting unit 330 receives a set illuminance value from an external portion and outputs the set illuminance value to the driving controller 340. The illuminance setting unit 330 may be constructed in a switch form which can be manually adjusted by a user. Alternatively, the illuminance setting unit 330 may be constructed in various forms.

The constant current sustaining unit 350 generates a second control signal and outputs the second control signal to the driving controller 340 so that a constant current is flowed in the LED module 400.

The constant current sustaining unit 350 includes a current measurement module 352 and a reference current value setting unit 354. A current measurement module 352 measures a magnitude of a current flowing the LED module 400 by measuring a voltage value of a resistor connected to the LED module 400, compares the measured magnitude of the current with a reference current value, and outputs a comparison signal (second control signal). A reference current value setting unit 354 adjusts a magnitude of the reference current value used for the current measurement module 352.

In order to maintain constant illuminance, the current flowing in the LED module 400 needs to be maintained constant. However, in the case where the illuminance is changed due to an external factor, the pulse width of the power applied to the LED module 400 needs to be changed in order to match the changed illuminance with the set illuminance again.

Therefore, the current measurement module 352 compares the measured current with a reference current. In the case where the measured current is lower than the reference current, the second control signal instructing the duty ratio to be increased is output to the driving controller 340. In the case where the measured current is higher than the reference current, the second control signal instructing the duty ratio to be decreased is output to the driving controller 340.

In addition, the reference current value setting unit 354 changes the reference current value according to the maximum voltage of the power pulse applied to the LED module 400. At this time, if the voltage value which is to be applied to the LED module 400 is determined by the driving controller 340, the reference current value setting unit 354 can receive the corresponding signal from the driving controller 340 to set the reference current value.

The driving controller 340 receives the set illuminance value and the second control signal and outputs a first control signal of determining the operation period of the transformation circuit 320 and the magnitude of the transformed power voltage which is to be output from the transformation circuit 320, to the transformation circuit 320.

In the preferred embodiment of the present invention, in the case where the transformation circuit 320 is constructed with a transformer and a plurality of switches which adjust the turns ratio of the transformer, the driving controller 340 outputs the first control signal to any one of the switches so that the power voltage (for example, V1 or V2 in FIG. 3) corresponding to the set illuminance value is supplied to the LED module 400 according to the set illuminance value. In addition, the driving controller 340 outputs the PWM control signal having a duty ratio corresponding to the set illuminance value as the first control signal to the switch, so that the power in a pulse form having a duty ratio corresponding to the duty ratio of the PWM control signal is supplied to the LED module 400.

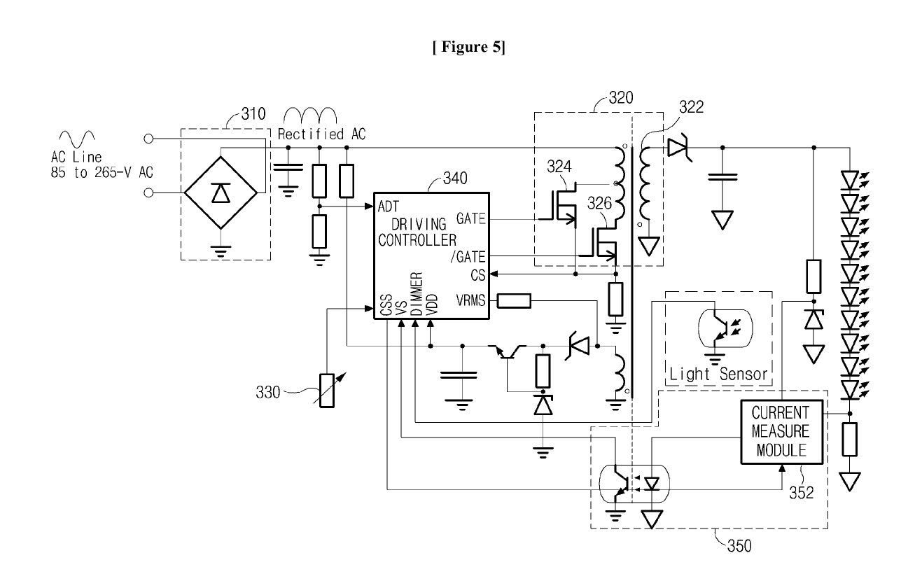

FIG. 5 is a circuit diagram illustrating a circuit configuration of the LED illumination driving apparatus according to the preferred embodiment of the present invention. Referring to FIG. 5, an AC power voltage ranging from 85V to 265V of 60 Hz is applied to the rectifier 310 which is constructed with a bridge circuit. The AC power voltage is full-wave rectified by the rectifier 310, so that a DC power voltage of 120 Hz which is not smoothed is output to the transformation circuit 320.

The transformation circuit 320 is constructed with a transformer 322 and two MOSFETs. The drain of the second MOSFET 326 is connected to an end portion of the primary winding, and the drain of the first MOSFET 324 is connected to a middle portion of the primary winding. If the first control signal is applied from the driving controller 340 to the gate of the second MOSFET 326 to turn on the second MOSFET 326, the current is flowed to the end portion of the primary winding. If the first control signal is applied from the driving controller 340 to the gate of the first MOSFET 324 to turn on the first MOSFET 324, the current is flowed only to the middle portion of the primary winding. Accordingly, the driving controller 340 can adjust the magnitude of the voltage supplied to the secondary winding by adjusting the turns ratio by turning any one of the first MOSFET 324 and the second MOSFET 326.

In the example illustrated in FIG. 3, the first MOSFET 324 is selected so as to transmit the power having the maximum voltage value V1 to the secondary winding of the transformer 322, and the second MOSFET 326 is selected so as to transmit the power having the maximum voltage value V2 to the secondary winding of the transformer 322.

In addition, the driving controller 340 outputs the internally-generated PWM control signal as the first control signal to the gate of the selected MOSFET, so that the MOSFET is turned on/off at a high speed. Therefore, the power applied to the primary winding is intermittently transmitted to the secondary winding. Accordingly, as illustrated in FIG. 4, the power pulse having the same duty ratio as that of the PWM control signal is induced to the secondary winding, so that the power pulse is supplied to the LED module 400.

On the other hand, if the power is supplied to the LED module 400, the LED module 400 is lit up, so that the current is flowed in the LED module 400 and the voltage in proportion to the current occurs in the resistor connected to the LED module 400.

The constant current sustaining unit 350 measures the voltage to measure the current flowing in the LED module 400, compares the measured current with an internal current reference value. If the current flowing in the LED module 400 is lower than the reference current, the constant current sustaining unit 350 outputs the second control signal instructing the duty ratio of the PWM signal to be increased to the driving controller 340. If the current flowing in the LED module 400 is higher than the reference current, the constant current sustaining unit 350 outputs the second control signal instructing the duty ratio of the PWM signal to be decreased to the driving controller 340.

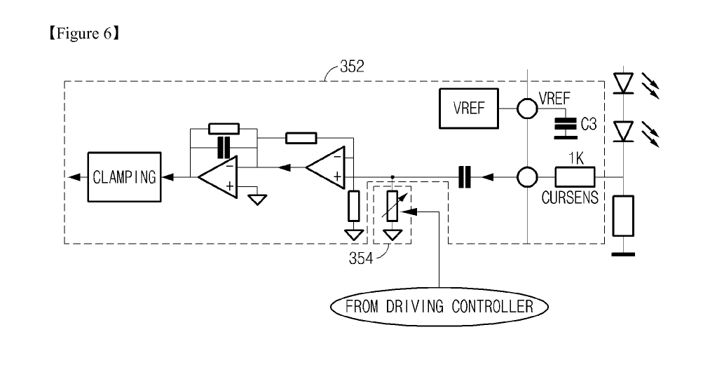

FIG. 6 is a diagram illustrating an example of a circuit of the current sensing module 352 of the constant current sustaining unit 350 according to the preferred embodiment of the present invention. Referring to FIG. 6, the current measurement module 352 of the constant current sustaining unit 350 includes a plurality of comparators, a clamping circuit, and a reference current value setting unit 354 which is constructed with a sensitivity adjusting resistor so as to adjust a magnitude of a reference current input to the comparators. As described above, as the driving controller 340 selects the MOSFET, the value of the sensitivity adjusting resistor is changed, so that the magnitude of the reference current is changed.

On the other hand, the driving controller 340 determines which one of the first MOSFET 324 and the second MOSFET 326 the first control signal is output to according to the set illuminance value input from the illuminance setting unit 330, in other words, the driving controller 340 determines the maximum voltage level of the power to be applied to the LED module 400. The driving controller 340 generates the PWM signal having a duty ratio corresponding to the determined maximum voltage level and outputs the PWM signal to the first MOSFET 324 or the second MOSFET 326. The driving controller 340 changes the duty ratio of the PWM signal according to the second control signal input from the constant current sustaining unit 350 at the set illuminance so that a constant current is flowed in the LED module 400.

In the meantime, in the case where the illuminance is changed by user's manipulation of the illuminance setting unit 330, the first control signal output to the first MOSFET 324 is output to the second MOSFET 326 so as to correspond to the illuminance, or the first control signal is reversely output.

For example, if the set illuminance value is gradually and continuously decreased from a high-sustained illuminance by a user for the dimming, the driving controller 340 decreases the duty ratio of the first control signal output to the first MOSFET 324. If the duty ratio reaches the threshold duty ratio, the driving controller 340 outputs the first control signal to the second MOSFET 326 and increases the duty ratio again. After that, the driving controller 340 gradually decreases the duty ratio again. Accordingly, it is possible to decrease the illuminance without occurrence of the flicker phenomenon.

In the aforementioned preferred embodiment, for the convenience of the description, the two switches constructed with MOSFETs are connected to the primary winding of the transformer, and the driving controller 340 selects one of the two switches according to the set illuminance value and the second control signal. However, in an actual case, three or more switches may be connected to the primary winding, and the driving controller 340 may select one of the switches by collectively taking into consideration a voltage value of an unsmoothed DC power input from the rectifier 310, the set illuminance value, and the second control signal to perform the PWM control.

For example, in the case where a plurality of the switches are connected to the primary winding of the transformer and a constant power having a duty ratio equal to or larger than the threshold duty ratio where the flicker phenomenon occurs is transmitted to the LED module 400, if the voltage level applied to the primary winding of the transformer is increased from 0V to 265V, first, the driving controller 340 selects the switch for the primary winding of which the length is shorter according to the voltage level input from the rectifier 310 to perform the PWM control (as the input voltage level is increased, the duty ratio of the PWM control signal is gradually decreased).

In the case where, since the voltage level input from the rectifier 310 is gradually increased, the duty ratio of the power transmitted to the secondary winding by the PWM switching of the selected switch cannot be maintained to be equal to or larger than the threshold duty ratio, the driving controller 340 selects the next switch for the winding of which the length is set to be longer to perform the PWM control.

In the same manner, one of the switches may be selected according to a change in the voltage value of the unsmoothed DC power input from the rectifier 310, and the PWM control may be performed in the selected switch.

As a result, the driving controller 340 selects the switch by collectively taking into consideration the voltage value of the unsmoothed DC power input from the rectifier 310, the set illuminance value, and the second control signal and transmits the power to the LED module 400 while changing an operating duty ratio in the selected switch.

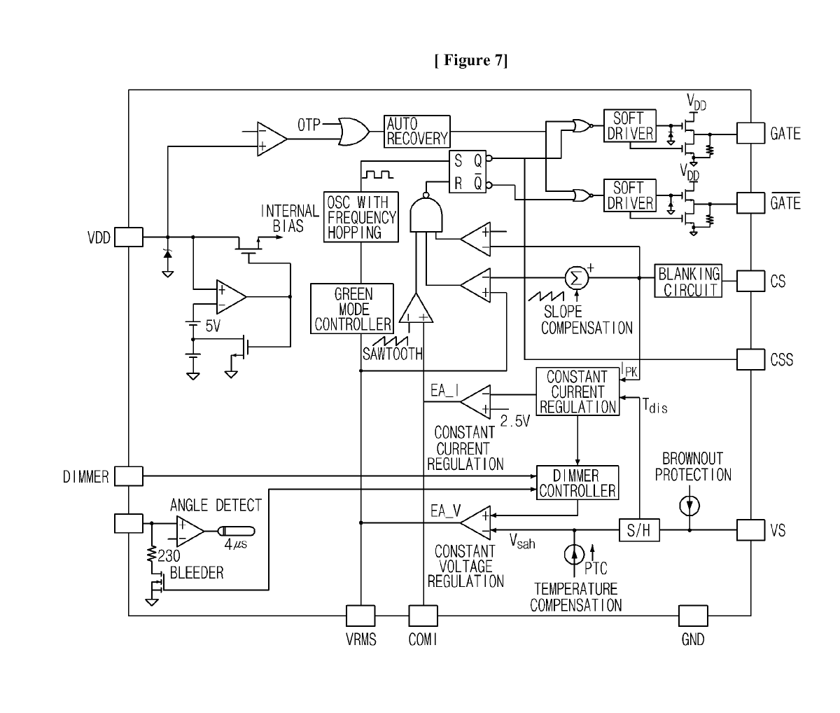

FIG. 7 is a circuit diagram illustrating a detailed configuration of the driving controller 340 according to the preferred embodiment of the present invention.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. An LED illumination driving apparatus comprising:
a rectifier which rectifies an input AC power;
a transformation circuit which transforms a magnitude of a DC power input from the rectifier according to a first control signal and outputs the transformed DC power to an LED module;
an illuminance setting unit which receives a set illuminance value as an input;
a constant current sustaining unit which generates a second control signal so that a constant current is flowed in the LED module; and
a driving controller which receives the set illuminance value and the second control signal as input and outputs the first control signal determining an operation period of the transformation circuit and a magnitude of the transformed power which is to be output from the transformation circuit.

2. The LED illumination driving apparatus according to claim 1, wherein the transformation circuit includes:
a transformer including a primary winding connected to the rectifier and a secondary winding connected to the LED module; and
a plurality of switches which turn on according to the first control signal to change the number of turns of the primary winding and adjust an operation time of the transformer.

3. The LED illumination driving apparatus according to claim 2, wherein the driving controller outputs the first control signal to any one of the switches according to the set illuminance value.

4. The LED illumination driving apparatus according to claim 3, wherein the driving controller outputs the first control signal to any one of the switches according to the set illuminance value and an unsmoothened DC power value input from the rectifier.

5. The LED illumination driving apparatus according to claim 3, wherein the plurality of switches are constructed with MOSFETs, wherein the first control signal is applied to the gates of the MOSFETs, and wherein the drain of one of the MOSFETs is connected to an end portion of the primary winding and the drain of another MOSEFT is connected to a middle portion of the primary winding, so that the magnitude of the power transmitted to the LED module is changed by changing the turns ratio of the transformer.

6. The LED illumination driving apparatus according to claim 5, wherein the driving controller generates a PWM control signal as the first control signal and controls the operation time of the transformer by changing a duty ratio of the PWM control signal.

7. The LED illumination driving apparatus according to claim 6, wherein the constant current sustaining unit includes:
a current measurement module which measures a magnitude of the current flowing in the LED module, comparing the magnitude of the current with a reference current value, and outputting the second control signal; and
a reference current value setting unit which adjusts a magnitude of the reference current value.

8. The LED illumination driving apparatus according to claim 7, wherein the reference current value setting unit changes the magnitude of the reference current value corresponding to the switch, which receives the first control signal as input, among the plurality of switches.
